(19) United States
(12) Patent Application Publication
(10) Pub. No.: US 2015/0222421 A1
(43) Pub. Date: Aug. 6, 2015

(54) COUNTERMEASURES AGAINST SIDE-CHANNEL ATTACKS ON CRYPTOGRAPHIC ALGORITHMS

(71) Applicant: QUALCOMM Incorporated, San Diego, CA (US)

(72) Inventors: Xiaofei Guo, Brooklyn, NY (US); Xu Guo, San Diego, CA (US); Billy B. Brumley, San Diego, CA (US)

(73) Assignee: QUALCOMM Incorporated, San Diego, CA (US)

(21) Appl. No.: 14/171,558

(22) Filed: Feb. 3, 2014

(51) Int. Cl. H04L 9/00; H04L 9/08

(52) U.S. Cl. CPC H04L 9/003; H04L 9/0869; H04L 2209/24

(57) ABSTRACT

Techniques for encrypting data are provided that can be used to help prevent side-channel attacks on the cryptographic algorithms. An example method according to these techniques includes permuting an order of first intermediate data according to a predetermined permutation to produce permuted intermediate data. The first inter mediate data is output by one or more first stages of a cryptographic algorithm. The method also includes permuting a key to be used by one or more second stages of a cryptographic algorithm according to the predetermined permutation, applying the one or more second stages of a cryptographic algorithm to the permuted intermediate data to generate second intermediate data, the one or more second stages of the cryptographic algorithm using the permuted key, and permuting the second intermediate data according to an inverse permutation of the predetermined permutation to generate output.

### BACKGROUND

Various encryption techniques can be used to prevent unauthorized access and/or modification to protected data. However, some encryption techniques may be vulnerable to side-channel attacks. Side-channel attacks are attacks that are based on information that is gained from the physical implementation of a cryptographic system and is not typically a brute force attack on the cryptographic algorithm or an attack on a theoretical weakness inherent in the algorithm. Side-channel attacks can be used to gather information about how the cryptographic algorithm operates, including cryptographic keys, partial state information, and/or full or partial plaintext information regarding the information being encrypted.

Power analysis and electromagnetic (EM) attacks are examples of two types of side-channel attacks that may be used to compromise cryptographic algorithms. In a power analysis attack, an attacker monitors the power consumption of a device that has implemented the cryptographic algorithm under attack. Power analysis attacks can vary in complexity. Simple power analysis (SPA) attacks involve interpreting power traces, which are graphs of electrical activity over time, produced by the hardware implementing the cryptographic algorithm under attack in order to derive information about the cryptographic algorithm. Differential power analysis (DPA) involve a more advanced power analysis attack technique that applies statistical analysis to the data collected from multiple cryptographic operations performed by the device under attack. The statistical analysis can provide the attacker with information that can be used to determine intermediate values within the cryptographic algorithm under attack. In an EM attack, the attacker monitors electromagnetic emanations from the hardware that has implemented the cryptographic algorithm. An attacker can analyze these emanations to derive information about the electrical currents flowing through the hardware and use that information to identify events occurring within the device during each clock cycle. Other types of side-channel attacks include differential fault analysis where faults are introduced into the cryptographic computations in an attempt to reveal information about the cryptographic algorithm, timing attacks where the attack is based on measuring how long certain computation tasks take to perform while the cryptographic algorithm is being executed, and acoustic attacks where the attack is based on sounds emanating from the hardware of the device implementing the cryptographic algorithm under attack while the cryptographic algorithm is being executed.

Many devices, such as mobile phones, tablet computers, laptops, and/or other such devices are constructed using digital circuits based on complementary metal-oxide-semiconductors (CMOS) technology. CMOS technology is commonly used in digital logic circuits, static random access memory (SRAM), microprocessors, and microcontrollers. CMOS implementations can be susceptible to power analysis and EM attacks. The static power consumption of CMOS digital circuits is typically very low. When CMOS digital circuits are clocked with different inputs, the digital circuits change states. These state changes lead to the charging and discharging of internal capacitors. The resulting voltage fluctuations depend on the data being computed. A malicious party that wishes to break the encryption scheme can monitor the power consumption of the device and/or the EM emanations from the device to correlate data being received with the power consumption and/or EM emanations. Analyzing the results of such testing can reveal the key used by the encryption scheme, intermediate values generated by the cryptographic algorithm, and/or other information that an attacker may be able to exploit to comprise the encryption algorithm.

FIG. 1 illustrates an example process that could be used to conduct a power analysis attack on a cryptographic algorithm. The power analysis attack illustrated in FIG. 1 makes use of a brute force approach to attempt to determine the key used by the encryption algorithm. The example process illustrated in FIG. 1 is used to attack an Advanced Encryption Standard (AES) algorithm, but similar procedures can be used to attack other types of encryption techniques. In order for a power analysis attack to be successful, the attacker must know the algorithm that is under attack so that a power model for simulating that hypothetical power consumption can be made, and the attacker must know which power traces of the circuit correlate with the data being computed. Using this information, an attacker could conduct a power analysis attack on the cryptographic algorithm used by a particular device using the following steps:

(1) Intermediate results of the executed cryptographic algorithm can be selected. For example, if the attacker is aware that a particular device has implemented a version of the Advanced Encryption Standard (AES) algorithm, the attacker could select the output of the first round of the AES algorithm implemented on the device as the point of attack. The attacker could select other rounds of the AES algorithm as well. For example, the next to last round of the AES algorithm may also be targeted by attackers.
(2) Hypothetical intermediate values based on plaintext input and key hypotheses can be generated. For example, hypothetical intermediate values can be generated by providing the encryption algorithm with a known plaintext value and a set of key hypotheses. Returning to the AES example, the hypotheses intermediate values can be the output of first round of the AES algorithm or whichever round of the AES algorithm that the attacker has targeted.
(3) The hypothetical intermediate values can then be mapped to an abstract power consumption model. The abstract power consumption model is based on the cryptographic algorithm that is being attacked (stage 103). The power consumption will vary depending upon the type of cryptographic algorithm and the power consumption can be estimated for various stages or rounds of the cryptographic algorithm.
(4) Power traces of the targeted stage of the cryptographic algorithm can then be measured on a real mobile device that is configured to use to cryptographic algorithm that is being attacked (stage 104). Power traces are graphs of the electrical current used over time and the power traces may reveal attributes of the various rounds or stages of the cryptographic algorithm that can allow the attacker to derive the keys.
(5) The power traces can then be correlated with the abstract consumption model to try to identify the key or at least a portion of the key associated with the cryptographic algorithm (stage 105).

### SUMMARY

An example method for encrypting data according to the disclosure includes permuting an order of first intermediate data according to a predetermined permutation to produce permuted intermediate data, the first inter mediate data being output by one or more first stages of a cryptographic algorithm. The method also includes permuting a key to be used by one or more second stages of the cryptographic algorithm according to the predetermined permutation, applying the one or more second stages of the cryptographic algorithm to the permuted intermediate data to generate second intermediate data, the one or more second stages of the cryptographic algorithm using the permuted key, and permuting the second intermediate data according to an inverse permutation of the predetermined permutation to generate output.

Implementations of such a method may include one or more of the following features. Applying the one or more first stages of the cryptographic algorithm to data to be encrypted to generate the first intermediate data. Selecting a permutation from a set of permutations, wherein permuting the order of the first intermediate data according to the predetermined permutation to produce permuted intermediate data comprises permuting the order of the first intermediate data using the selected permutation. Selecting the permutation from the set of permutations includes generating a random number seed value, and selecting the permutation from the set of permutations based on the random number seed value. Selecting the permutation from the set of permutations includes selecting the permutation from the set of permutations based on a predetermined pattern. Permuting the second intermediate data according to the inverse permutation of the predetermined permutation to generate the output includes selecting the inverse permutation from a set of inverse permutations based on the selected permutation. The cryptographic algorithm is an Advanced Encryption Standard (AES) algorithm, and wherein the one or more first stages of the cryptographic algorithm comprise a first round of the AES algorithm and the one or more second stages of the cryptographic algorithm comprise a second round of the AES algorithm or the one or more first stages of the cryptographic algorithm comprise a next to last round of the AES algorithm and the one or more second stages of the cryptographic algorithm comprise a final round of the AES algorithm.

A system for encrypting data according to the disclosure includes means for permuting an order of first intermediate data according to a predetermined permutation to produce permuted intermediate data, the first inter mediate data being output by one or more first stages of a cryptographic algorithm; means for permuting a key to be used by one or more second stages of a cryptographic algorithm according to the predetermined permutation, means for applying the one or more second stages of the cryptographic algorithm to the permuted intermediate data to generate second intermediate data, the one or more second stages of the cryptographic algorithm using the permuted key, and means for permuting the second intermediate data according to an inverse permutation of the predetermined permutation to generate output.

Implementations of such a system may include one or more of the following features. Means for applying the one or more first stages of the cryptographic algorithm to data to be encrypted to generate the first intermediate data. Means for selecting a permutation from a set of permutations, and the means for permuting the order of the first intermediate data according to the predetermined permutation to produce permuted intermediate data comprises means for permuting the order of the first intermediate data using the selected permutation. The means for selecting the permutation from the set of permutations includes means for generating a random number seed value, and means for selecting the permutation from the set of permutations based on the random number seed value. The means for selecting the permutation from the set of permutations includes means for generating a random number seed value, and means for selecting the permutation from the set of permutations based on the random number seed value. The means for permuting the second intermediate data according to the inverse permutation of the predetermined permutation to generate the output includes means for selecting the inverse permutation from a set of inverse permutations based on the selected permutation. The cryptographic algorithm is an Advanced Encryption Standard (AES) algorithm, and wherein the one or more first stages of the cryptographic algorithm comprise a first round of the AES algorithm and the one or more second stages of the cryptographic algorithm comprise a second round of the AES algorithm or the one or more first stages of the cryptographic algorithm comprise a next to last round of the AES algorithm and the one or more second stages of the cryptographic algorithm comprise a final round of the AES algorithm.

A non-transitory computer readable medium according to the disclosure has stored thereon computer-readable instructions for encrypting data. The medium comprises instructions configured to cause a computer to permute an order of first intermediate data according to a predetermined permutation to produce permuted intermediate data, the first inter mediate data being output by one or more first stages of a cryptographic algorithm; permute a key to be used by one or more second stages of the cryptographic algorithm according to the predetermined permutation; apply the one or more second stages of the cryptographic algorithm to the permuted intermediate data to generate second intermediate data, the one or more second stages of the cryptographic algorithm using the permuted key; and permute the second intermediate data according to an inverse permutation of the predetermined permutation to generate output.

Implementations of such a non-transitory computer readable medium may include one or more of the following features. Instructions configured to cause the computer to apply the one or more first stages of the cryptographic algorithm to data to be encrypted to generate the first intermediate data. Instructions configured to cause the computer to select a permutation from a set of permutations, and the instructions configured to cause the computer to permute the order of the first intermediate data according to the predetermined permutation to produce permuted intermediate data include instructions configured to cause the computer to permute the order of the first intermediate data using the selected permutation. The instructions configured to cause the computer to select the permutation from the set of permutations include instructions configured to cause the computer to generate a random number seed value, and select the permutation from the set of permutations based on the random number seed value. The instructions configured to cause the computer to select the permutation from the set of permutations include instructions configured to cause the computer to select the permutation from the set of permutations based on a predetermined pattern. The instructions configured to cause the computer to permute the second intermediate data according to the inverse permutation of the predetermined permutation to generate the output include instructions configured to cause the computer to select the inverse permutation from a set of inverse permutations based on the selected permutation. The cryptographic algorithm is an Advanced Encryption Standard (AES) algorithm, and wherein the one or more first stages of the cryptographic algorithm comprise a first round of the AES algorithm and the one or more second stages of the cryptographic algorithm comprise a second round of the AES algorithm or the one or more first stages of the cryptographic algorithm comprise a next to last round of the AES algorithm and the one or more second stages of the cryptographic algorithm comprise a final round of the AES algorithm.

A circuit for encrypting data according to the disclosure includes a first set of components configured to permute an order of the first intermediate data according to a predetermined permutation to produce permuted intermediate data, the first inter mediate data being output by one or more first stages of a cryptographic algorithm, a second set of components configured to permute a key to be used by one or more second stages of the cryptographic algorithm according to the predetermined permutation, a third set of components configured to apply the one or more second stages of the cryptographic algorithm to the permuted intermediate data to generate second intermediate data, the one or more second stages of the cryptographic algorithm using the permuted key, and a fourth set of components configured to permute the second intermediate data according to an inverse permutation of the predetermined permutation to generate output.

Implementations of such a circuit may include one or more of the following features. A fifth set of components configured to apply the one or more first stages of the cryptographic algorithm to data to be encrypted to generate the first intermediate data. A sixth set of components configured to select a permutation from a set of permutations, wherein permuting the order of the first intermediate data according to the predetermined permutation to produce permuted intermediate data comprises permuting the order of the first intermediate data using the selected permutation. The sixth set of components is further configured to generate a random number seed value, and select the permutation from the set of permutations based on the random number seed value. The sixth set of components is further configured to select the permutation from the set of permutations based on a predetermined pattern. The fourth set of components is configured to select the inverse permutation from a set of inverse permutations based on the selected permutation. The cryptographic algorithm is an Advanced Encryption Standard (AES) algorithm, and wherein the one or more first stages of the cryptographic algorithm comprise a first round of the AES algorithm and the one or more second stages of the cryptographic algorithm comprise a second round of the AES algorithm or the one or more first stages of the cryptographic algorithm comprise a next to last round of the AES algorithm and the one or more second stages of the cryptographic algorithm comprise a final round of the AES algorithm.

### BRIEF DESCRIPTION OF THE DRAWINGS

FIG. 1 illustrates an example process that could be used to conduct a power analysis attack on a cryptographic algorithm.

FIG. 2 is an illustration that provides a comparison of countermeasures that may be used to decrease the likelihood of success of a power analysis attack on a cryptographic algorithm.

FIG. 3 is an illustration that provides a comparison of a round of a conventional AES cryptographic algorithm with a modified AES cryptographic algorithm according to the techniques disclosed herein.

FIG. 4 illustrates a comparison between the rounds of a conventional AES-192 implementation with a modified AES-192 implementation that utilizes the techniques disclosed herein.

FIG. 5A is functional diagram of a circuit that can be used to implement a conventional AES-128 algorithm.

FIG. 5B is functional diagram of a circuit that can be used to implement a modified AES-128 algorithm that uses the algorithm transformation technique to introduce randomization into the AES-128 algorithm.

FIG. 5C is functional diagram of a circuit that can be used to implement a modified AES-128 algorithm that uses the algorithm randomization technique to introduce randomization into the AES-128 algorithm.

FIG. 6 is a block diagram of a mobile device 600 that can be used to implement the techniques disclosed herein.

FIG. 7 is a functional block diagram of the mobile device illustrated in FIG. 6 that illustrates functional modules of the memory shown in FIG. 6.

FIG. 8 is a flow diagram of a process for encrypting data that can be used to implement the encryption techniques disclosed herein.

### DETAILED DESCRIPTION

Techniques disclosed herein can be used to help prevent side-channel attacks on cryptographic algorithms. For example, the techniques disclosed herein can help to prevent power analysis and/or EM attacks on cryptographic algorithms and may also provide protections against other types of side-channel attacks on the cryptographic algorithms. The techniques disclosed herein can be used to introduce randomization into the cryptographic algorithm that can make side-channel attacks on cryptographic algorithms much more difficult. Examples of the techniques disclosed herein have been illustrated using examples using Advanced Encryption Standard (AES) algorithms. However, the techniques disclosed herein can also be applied to other types of cryptographic algorithms as well. The techniques herein can be used for cryptographic algorithm implementation that hardware-based, software-based, or a combination thereof.

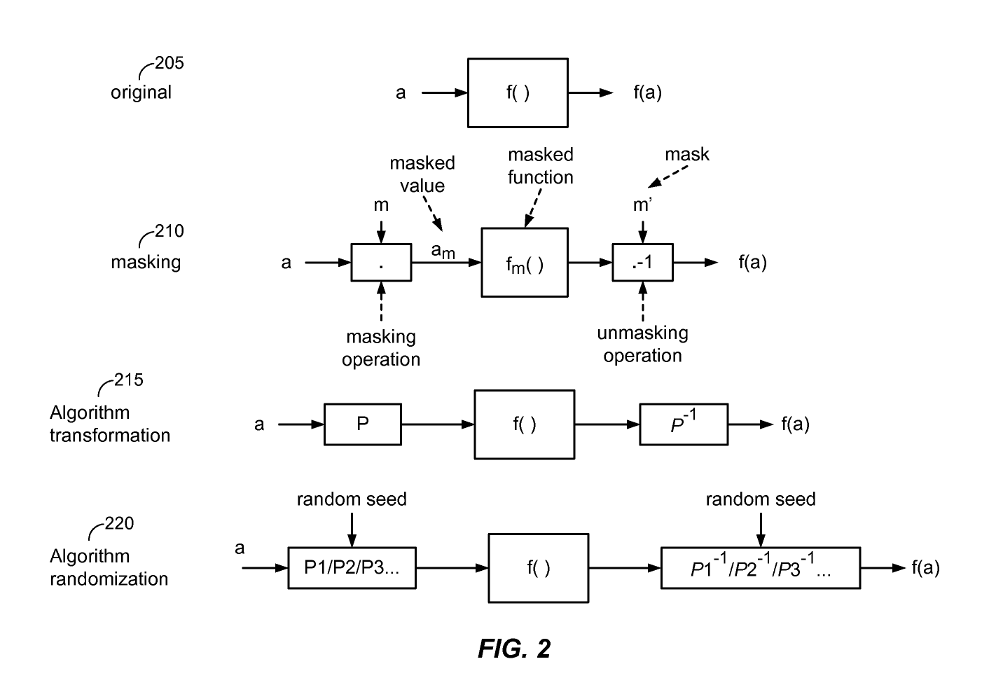

FIG. 2 is an illustration that provides a comparison of countermeasures that may be used to decrease the likelihood of success of a power analysis attack on a cryptographic algorithm. The countermeasures can be divided into two categories: (1) hiding techniques, and (2) masking techniques. In hiding techniques, circuit level design techniques can be applied to keep the power consumption of the digital circuitry implementing the cryptographic algorithm approximately the same even when different inputs are provided to the cryptographic algorithms. In masking techniques, the cryptographic algorithms is designed to randomize power consumption by masking data using a random mask while the algorithms are operating on the data and to remove the mask after the computation are completed. The techniques disclosed herein are variations of masking techniques that help to randomize power consumption while the cryptographic algorithm is being executed to make it much more difficult for an attacker to analyze data collected through a side-channel attack to break the cryptographic algorithm.

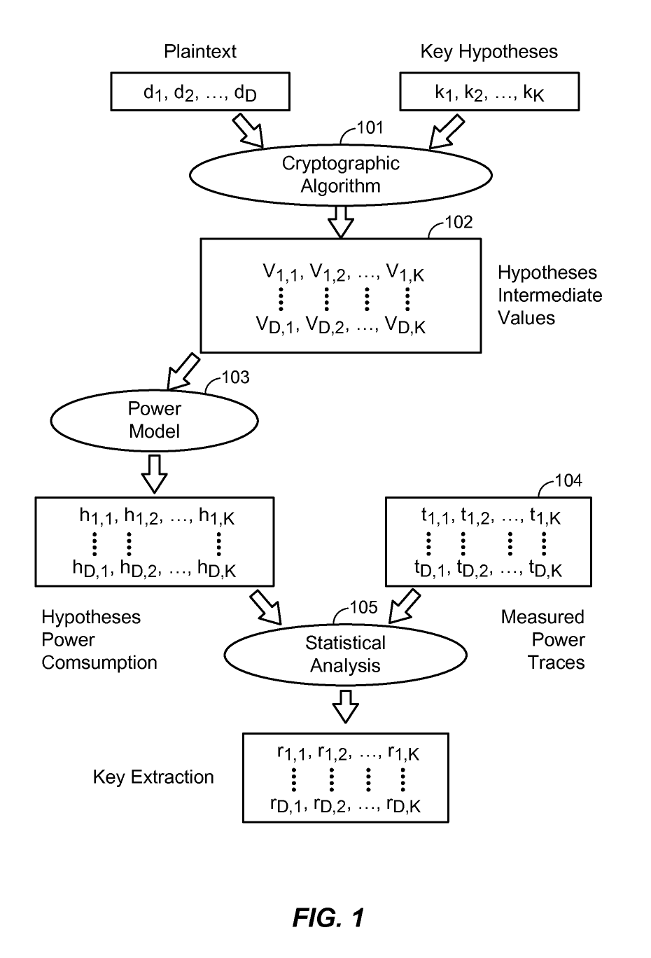

A flow diagram of an original cryptographic algorithm 205 illustrates than an input value a is provided to a cryptographic function f and the cryptographic function outputs an encrypted version of the input value a (referred to as f(a) in FIG. 1). The original cryptographic algorithm 205 represents a generic cryptographic algorithm and is not limited to AES or any other specific cryptographic technique. The original cryptographic algorithm 205 does not take any steps to prevent power analysis attacks, EM attacks, or other types of side-channel attacks. Accordingly, the original cryptographic algorithm 205 may be susceptible to side-channel attacks that could reveal intermediate data associated with the cryptographic algorithm, keys associated with the algorithm, and/or other information that an attacker could use to break the cryptographic algorithm.

A masking technique is illustrated by masking cryptographic algorithm 210. The masking cryptographic algorithm 210 is a modified version of the original cryptographic algorithm 205 that includes masking and unmasking steps. The masking cryptographic algorithm 210 can randomize power consumption by the cryptographic algorithm in and attempt to thwart power analysis and EM attacks on the cryptographic algorithm. In masking cryptographic algorithm 210, a masking operation is applied to the input value a to generate a masked input value aₘ using a mask value m. The masked input value aₘ is then provided to a masked version of the cryptographic function fₘ. The output from the a masked version of the cryptographic function fₘ is then unmasked with an unmasking operation in order to obtain the f(a) value that was obtained in the original cryptographic algorithm 205. The masking cryptographic algorithm 210 requires that the original cryptographic function be modified to work with the masked values in order for the power consumption associated with the cryptographic processing to be randomized.

FIG. 2 also illustrates two techniques that are disclosed herein that can be used to introduce randomization into the cryptographic algorithm to make a power analysis attack, an EM attack, or other types of side-channel attack on the cryptographic algorithm much more difficult. The first technique is an algorithm transformation technique and the second technique is an algorithm randomization technique. Both techniques can be used to add randomization to one or more stages of a cryptographic algorithm without requiring that the cryptographic function be modified as in the masking cryptographic algorithm 210.

The transformation algorithm 215 applies a transformation function P which permutes the input value a before the input value a is operated upon by the cryptographic function f. The permutation reorders to the bytes of the input value that is provided to the cryptographic function f. The cryptographic function exhibits round level or stage level invariance, which means that the order of the bytes of the input can be permuted according to the transformation function P and input into the cryptographic function f without affecting the output of the cryptographic function f. The order of the bytes of the output of the cryptographic function f will be permuted due to the application of the transformation function P. However, an inverse permutation function P⁻¹, which is the inverse of the transformation function P, to reorder the bytes of the permuted output of the cryptographic function to match the output of the original cryptographic algorithm 205.

The randomization algorithm 220 provides additional protection over the transformation algorithm 215 by selecting from one of multiple permutation functions rather than applying the same permutation function to the input value a each time that the cryptographic algorithm is executed. The randomization algorithm 220 is configured to select from two or more transformation functions that can permute the order of the bytes of the input value a. In example illustrated in FIG. 2, the selection of which transformation function to apply to the input value a is determined using a random seed value. The random seed value is then used to select the inverse permutation function corresponding to the permutation function from the plurality of inverse permutation functions. Other techniques can also be used to select which transformation function is to be applied to the input value a. For example, a round robin or other selection scheme can be used instead of the random seed value to select which transformation function is to be applied to the input value a. In some implementations one or more fixed selection patterns may be implemented and can be used instead of a random seed to determine which transformation function is to be applied.

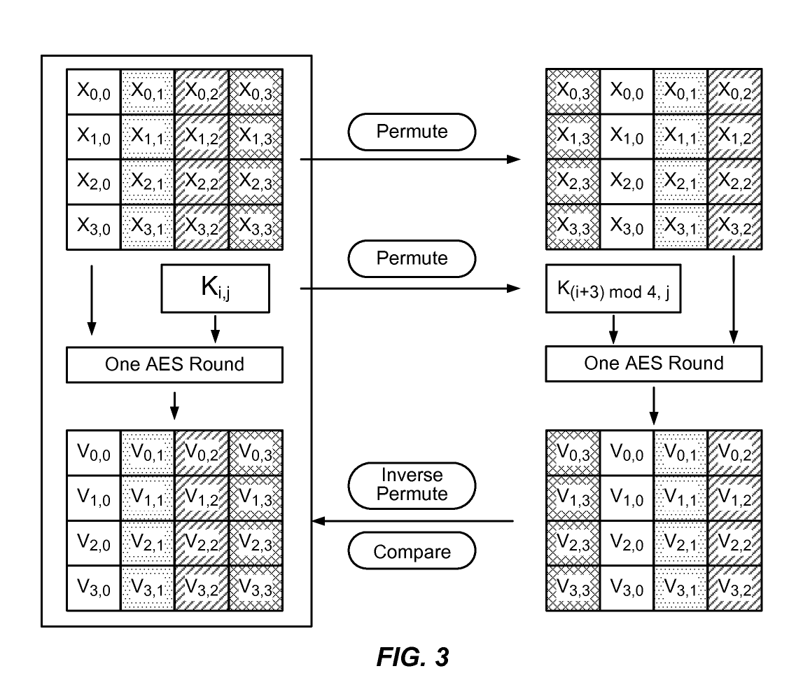

FIG. 3 is an illustration that provides a comparison of a round of a conventional AES cryptographic algorithm with a modified AES cryptographic algorithm according to the techniques disclosed herein. The AES cryptographic algorithms exhibit round level invariance, which means that the order of the bytes of the input data can be permuted using a transformation function in order to add additional randomization to the AES algorithm. The left column of FIG. 3 illustrates the inputs and outputs of a round of a conventional AES cryptographic algorithm and the right column illustrates the inputs and outputs of a round of a modified AES cryptographic algorithm according to the disclosure. The modified AES technique may be implemented using either the transformation algorithm or the randomization algorithm techniques illustrated in FIG. 2. If the transformation algorithm technique is applied, the transformation algorithm that applies the permutation to the input values would be predetermined, and the permutation can be optionally applied to one or more rounds of the cryptographic algorithm. If the randomization algorithm technique is applied, the transformation algorithm that applies the permutation to the input values would be selected from one of multiple transformation algorithms that each permute the bytes of the input values in a different pattern or in some instances no permutation may be applied. Furthermore, a different transformation algorithm may be applied to different rounds of the cryptographic algorithm.

In the left column representing the conventional AES cryptographic algorithm, the input values to the conventional AES algorithm comprise 16 bytes of input data to which the encryption algorithm is to be applied. The data is represented by a 4×4 matrix in this example. The AES encryption algorithms require a separate key for each round that are derived from the main cipher key using Rijndael's key schedule, a technique which can be used to expand a short key into a number of separate round keys. Accordingly, the appropriate key for the round can be generated from the main cipher key being used for the AES session or the key may already be generated and can be accessed from memory.

In the right column representing the modified AES cryptographic algorithm using the techniques disclosed herein, the input values and the subkey associated with the round are both permuted according to a transformation function. The transformation function permutes the bytes within the input data and also performs an equivalent permutation on the key to be applied in the AES round depicted in FIG. 3 prior to performing the round of the AES cryptographic function. No changes need to be made to the AES cryptographic algorithm in order for the permutation function to be used in conjunction with the AES cryptographic algorithm, because the AES cryptographic algorithm is invariant for at least this round. The order of the bytes of the output of the AES round in which transformation technique has been applied illustrated in the right will column will differ from the order of the bytes of the output of the conventional AES encryption round illustrated in left column of FIG. 3. However, the bytes of the output of the AES round in which the transformation technique has been applied can be reordered using an inverse permutation of the permutation applied to the input data before the round of the AES cryptographic algorithm was performed. After applying the inverse permutation to output data in which the transformation technique has been applied, the output data in which the transformation technique has been applied will match the output of the round of the conventional AES round illustrated in the left column of FIG. 3. Permuting the bytes of input data prior to the round introduces randomization to the round which can make it more difficult for an attacker to use power analysis or EM attacks to break the cryptographic algorithm.

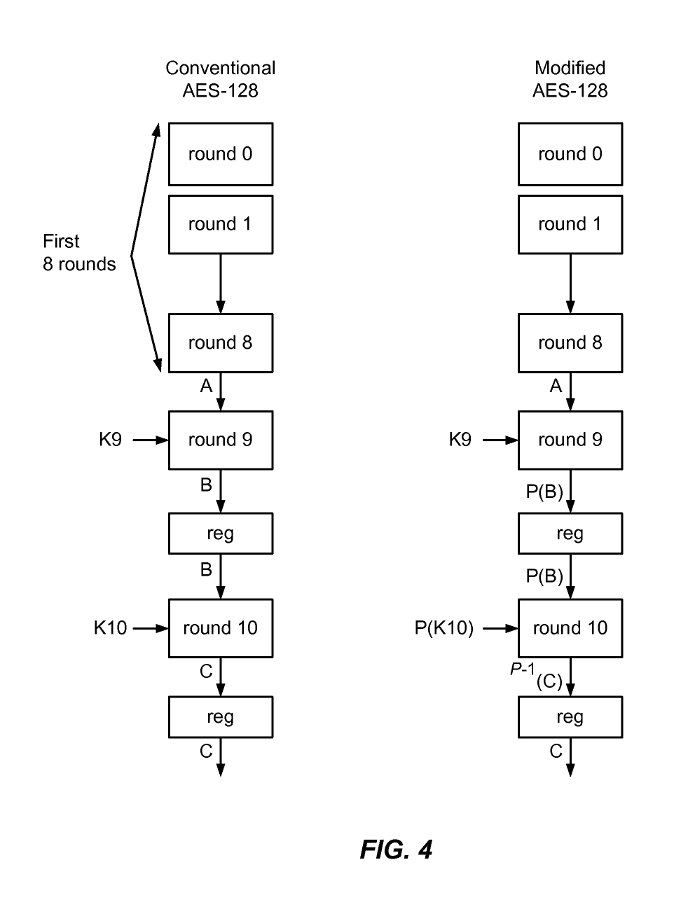

FIG. 4 illustrates a comparison between the rounds of a conventional AES-192 implementation with a modified AES-192 implementation that utilizes the techniques disclosed herein. In the example illustrated in FIG. 4, portions of the 9^{th} and 10^{th} rounds have been modified to protect the 10^{th} AES round. However, the technique illustrated herein can be used to protect any round of the AES algorithm. Furthermore, the transformation technique utilized herein can be applied to other version of the AES algorithm, such as AES-192 and AES-256, and/or to other cryptographic techniques as well. The AES-128 algorithm uses a key length of 128 bits, the AES-192 algorithm uses a key length of 192 bits, and the AES-256 algorithm uses a key length of 256 bits. While the example illustrated in FIG. 4 applies the techniques disclosed herein to the AES-192 algorithm, the techniques described herein can also be applied to other AES algorithms using keys having different sized bit lengths and/or having other variations to the algorithm.

The output from round 8 is A and the key input of round 9 is K9 for both the conventional AES-192 implementation and the modified AES-192 implementation. In the conventional AES-192 implementation, the output from round 9 is the value B and the key input of round 10 is the key K10 and the output from round 10 is the value C. In the modified AES-192 implementation, the first eight rounds of the algorithm are performed in the same way as in the conventional AES-192 implementation. But, the round 9 output is permuted using a transformation function and the permutated output is P(B). The key K10 of round 10 is also permuted using the same permutation function applied to the output of round 9. Round 10 is performed using the permuted data input matrix P(B) and permuted key P(K10). The output of round 10 is P⁻¹(C). This output is then inverse permuted using the inverse permutation of the permutation function applied to the output of round 9. The result of applying the inverse permutation to the output of round 10 produces the ciphertext C which is the same ciphertext output that round 10 of the conventional AES-192 implementation produced.

### Example Hardware

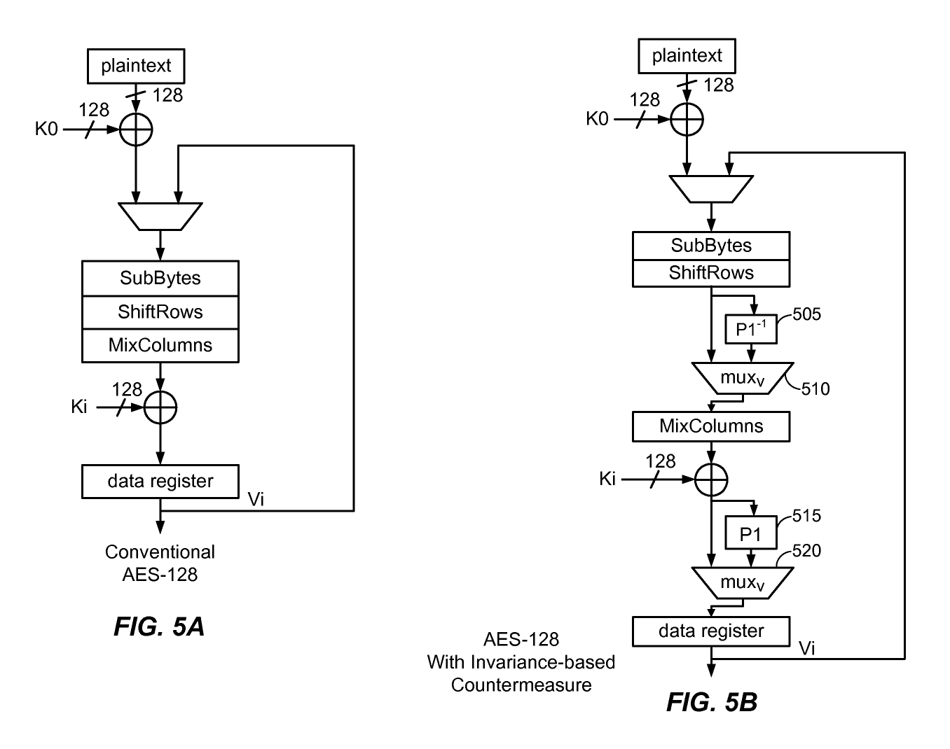

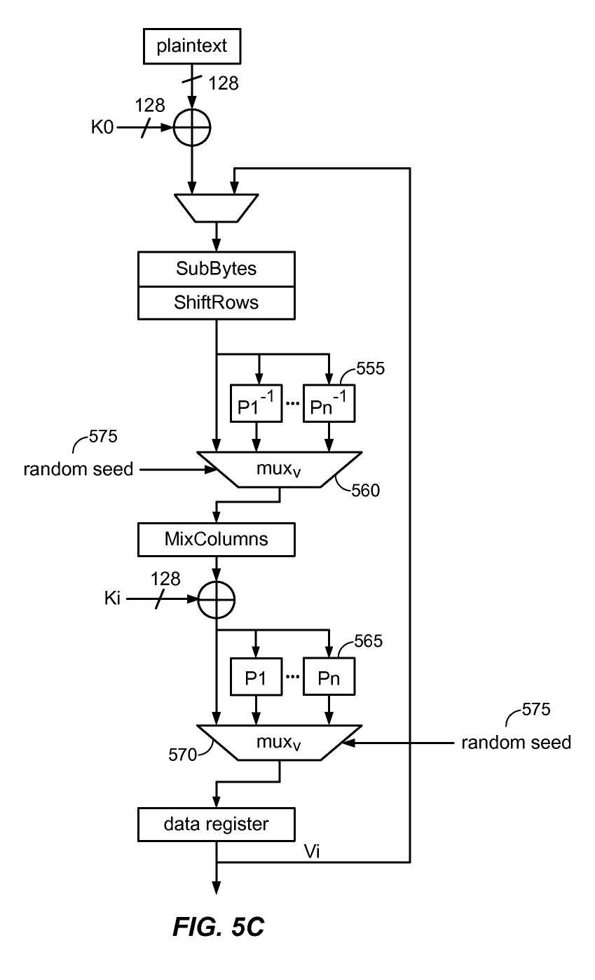

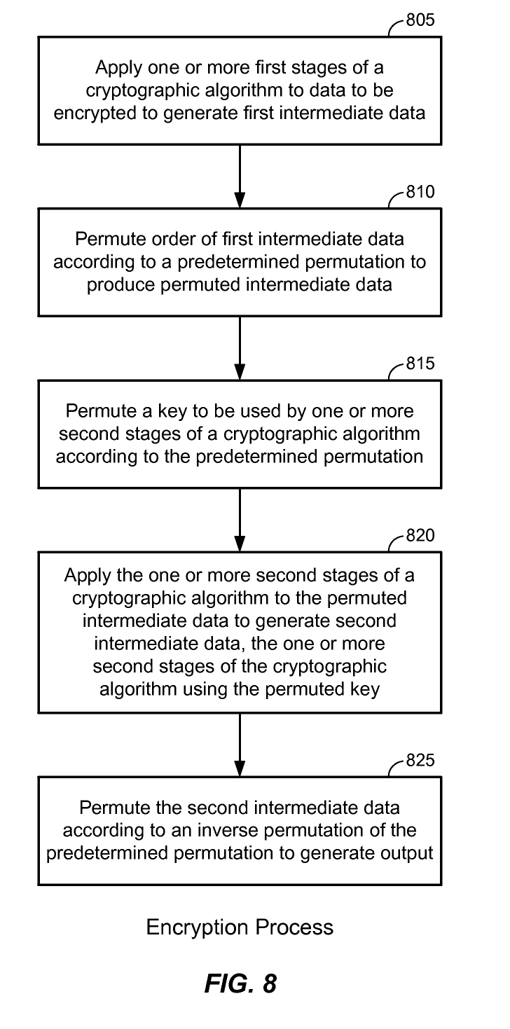

FIGS. 5A, 5B, and 5C are functional block diagrams illustrating circuits that can be used to implement the technique disclosed herein. FIG. 5A is functional diagram of a circuit that can be used to implement a conventional AES-128 algorithm. FIG. 5B is functional diagram of a circuit that can be used to implement a modified AES-128 algorithm that uses the algorithm transformation technique to introduce randomization into the AES-128 algorithm. FIG. 5C is functional diagram of a circuit that can be used to implement a modified AES-128 algorithm that uses the algorithm randomization technique to introduce randomization into the AES-128 algorithm. The circuits illustrated in FIGS. 5B and 5C can be used to implement the processes illustrated in FIG. 8. While the example embodiments illustrated in FIGS. 5B and 5C are directed to modified version of the AES-128 algorithm, similar modifications can be made to circuits implementing other version of the AES cryptographic algorithm and/or other cryptographic algorithms.

FIG. 5A illustrates a circuit that can be used to implement a round of a conventional AES-128 algorithm. The circuit is configured to receive a plaintext message to be encrypted and a cipher key from which the round keys associated with each round can be derived. The circuit includes functional blocks representing the SubBytes, ShiftRows, and MixColumns steps included in each round of the AES cryptographic algorithm. The AES-128 algorithm includes 10 rounds, and the appropriate key for the next round will be selected upon completion of the current round before looping back to the functional blocks representing the SubBytes, ShiftRows, and MixColumns steps of the AES-128 algorithm.

FIG. 5B is functional diagram of a circuit that can be used to implement a modified AES-128 algorithm that uses the algorithm transformation technique to introduce randomization into the AES-128 algorithm. Like the example illustrated in FIG. 5A, the circuit is configured to receive a plaintext message to be encrypted and a cipher key from which the round keys associated with each round can be derived. However, the example circuit illustrated in FIG. 5B includes additional components that support the algorithm transformation technique, which can be used to permute the order of the input data used by the steps of the AES round. In the example illustrated in FIG. 5B, the circuit includes a transformation function block 505 and a multiplexer 510 that were not included in the circuit implementing the conventional AES-128 round illustrated in FIG. 5A. In the circuit illustrated in FIG. 5B, the transformation function is applied to permute the order of the bytes of the data before the MixColumns step. However, in other implementations, the transformation function can be applied before the SubBytes step or before the ShiftRows step of the AES round. Furthermore, the placement of the transformation function block 505 and a multiplexer 510 can vary when a different cryptographic algorithm is implemented by the circuit. The output from the ShiftRows step functional block is fed into the transformation function block 505 which permutes the output from the ShiftRows step functional block according to the predetermined permutation implemented by the transformation function. The transformation function block 505 applies a permutation that changes the order of the bytes of the input data received by the transformation function block 505. The permuted data is then output to the multiplexer 510. The multiplexer 510 can then select between the original output from the ShiftRows step functional block and the permuted data output by the transformation function block 505. A select signal can be provided to the multiplexer 510 to cause the multiplexer 510 to select either the original output from the ShiftRows step functional block or the permuted data output by the transformation function block 505. Accordingly, the circuit can be configured to enable or disable the use of the transformation function at each round making a power analysis or EM attack more difficult as the transformation function as the attacker would not be aware of whether the transformation function was applied to a particular round or which that pattern was that was applied in the particular round.

The circuit also includes an inverse transformation function block 515 and a multiplexer 520. The inverse transformation function block 515 receives the output of the MixColumns step functional block and applies an inverse permutation to the output of the MixColumns step functional block. The inverse transformation function applies an inverse permutation that reorders the byes of the input received by the inverse transformation function block 515 block to what the order of the bytes was before the permutation was applied by the transformation function block 505. Accordingly, the output from a particular round from the circuit illustrated in FIG. 5B would be the same output value as would be obtained from the corresponding round of the conventional AES-128 algorithm implementation illustrated in FIG. 5A. The randomization introduced during the round can make a side-channel attack more difficult while not requiring any changes to the encryption algorithm.

FIG. 5C is functional diagram of a circuit that can be used to implement a modified AES-128 algorithm that uses the algorithm randomization technique to introduce randomization into the AES-128 algorithm. Like the example illustrated in FIGS. 5A and 5B, the circuit is configured to receive a plaintext message to be encrypted and a cipher key from which the round keys associated with each round can be derived. The circuit illustrated in FIG. 5C provides an example of algorithm randomization. The circuit includes multiple transformation function blocks 555 that are configured to receive the output of the ShiftRows step functional block. Each of the transformation function blocks 555 apply a different permutation to the order of the bytes of the input data received by that transformation function block. The permuted data is then output to the multiplexer 560. The multiplexer 560 can then select between the original output from the ShiftRows step functional block and the permuted data output by one of the transformation function blocks 555. In some implementations, a random seed value 575 can be generated and provided to the multiplexer 560 as a select value which determines which input the multiplexer 560 selects. Other techniques can also be used to determine a select value. For example, in some implementations, the circuit can be configured to select from one or more predetermined patterns that determine which input the multiplexer 560 selects.

The circuit illustrated in FIG. 5C also includes multiple inverse transformation function blocks 565 and a multiplexer 570. The inverse transformation function blocks 565 receive the output of the MixColumns step functional block and applies an inverse permutation to the output of the MixColumns step functional block. Each of the inverse transformation function blocks 565 corresponds to one of the transformation function blocks 555 and implements the inverse permutation of the corresponding transformation function blocks 555. The inverse transformation function applies an inverse permutation that reorders the byes of the input received by the inverse transformation function block 565 block to what the order of the bytes was before the permutation was applied by the transformation function block 555. Accordingly, the output from a particular round from the circuit illustrated in FIG. 5C would also be the same output value as would be obtained from the corresponding round of the conventional AES-128 algorithm implementation illustrated in FIG. 5A. The randomization introduced during the round can make a successful side-channel attack more difficult while not requiring any changes to the encryption algorithm. Furthermore, the addition of multiple possible permutations provides additional protection as a potential attacker would not be aware of which if any permutation that was applied to the data at that round.

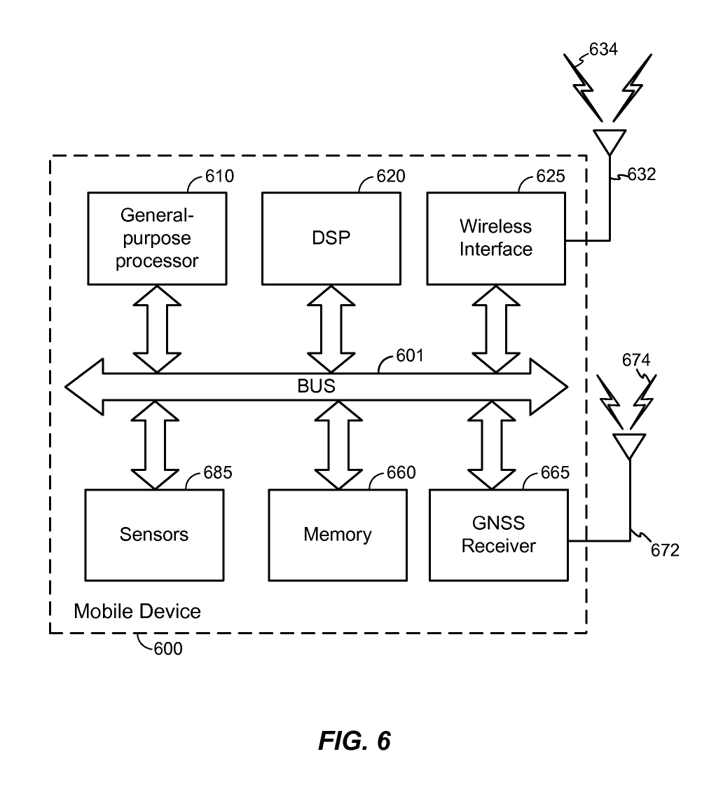

FIG. 6 is a block diagram of a mobile device 600 that can be used to implement the techniques disclosed herein. The mobile device 600 can be used to implement, at least in part, the process illustrated in FIG. 8. While the example device illustrated in FIG. 6 is a mobile device, the process illustrated in FIG. 8 can also be implemented in other types of computing devices, such as server, a desktop computer system, or other device that includes a processor that can execute processor-readable, processor-executable software code.

The mobile device 600 comprises a computer system including a general-purpose processor 610, a digital signal processor (DSP) 620, a wireless interface 625, a GNSS interface 665, and a non-transitory memory 660, connected to each other by a bus 601. Other implementations of the mobile device 600 may include additional elements not illustrated in the example implementation of FIG. 6 and/or may not include all of the elements illustrated in the example embodiment illustrated in FIG. 6. For example, some implementations of the mobile device 600 may not include the GNSS interface 665.

The wireless interface 625 can include a wireless receiver, transmitter, transceiver, and/or other elements that enable the mobile device 600 to send and/or receive data using WWAN, WLAN, and/or other wireless communication protocols. The wireless interface 625 can comprise one or more multi-mode modems capable of transmitting and receiving wireless signals using multiple wireless communications standards. The wireless interface 625 is connected by a line 632 to an antenna 634 for sending and receiving communications to/from devices configured to communicate using wireless communication protocols. While the mobile device 600 illustrated in FIG. 6 comprises a single wireless interface 625 and a single antenna 634, other implementations of the mobile device 600 can include multiple wireless interfaces 625 and/or multiple antennas 634.

The Global Navigation Satellite System (GNSS) interface 665 can include a wireless receiver and/or other elements that enable the mobile device 600 to receive signals from transmitters associated with one or more GNSS systems. The GNSS interface 665 is connected by a line 672 to an antenna 674 for receiving signals from the GNSS transmitters. The mobile device 600 can be configured to use signals received from satellites associated with satellites and other transmitters associated with the GNSS systems to determine a position of the mobile device 600. The mobile device 600 can also be configured to use the signals received from GNSS satellites and other transmitters associated with the GNSS systems in conjunction with signals received from terrestrial wireless transmitters to determine a position of the mobile device 600.

The DSP 620 can be configured to process signals received from the wireless interface 625 and/or the GNSS interface 665 and may be configured to process signals for or in conjunction with one or more modules implemented as processor-readable, processor-executable software code stored in memory 660 and/or can be configured process signals in conjunction with the processor 610.

The processor 610 can be an intelligent device, e.g., a personal computer central processing unit (CPU) such as those made by Intel® Corporation or AMD®, a microcontroller, an application specific integrated circuit (ASIC), etc. The memory 660 is a non-transitory storage device that can include random access memory (RAM), read-only memory (ROM), or a combination thereof. The memory 660 can store processor-readable, processor-executable software code containing instructions for controlling the processor 610 to perform functions described herein (although the description may read that the software performs the function(s)). The software can be loaded onto the memory 660 by being downloaded via a network connection, uploaded from a disk, etc. Further, the software may not be directly executable, e.g., requiring compiling before execution.

The software in the memory 660 is configured to enable the processor 610 to perform various actions, including implementing sending data to and/or receiving data from wireless transmitters, wireless base stations, other mobile devices, and/or other devices configured for wireless communication.

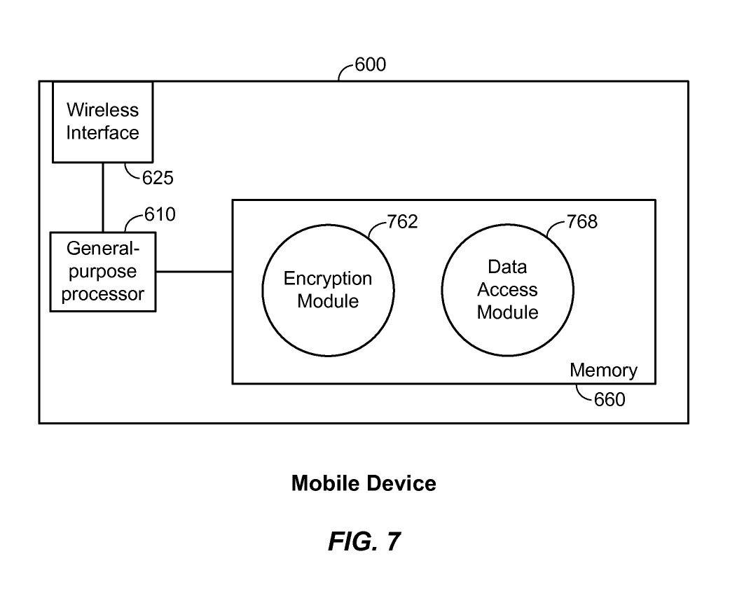

FIG. 7 is a functional block diagram of the mobile device 600 illustrated in FIG. 6 that illustrates functional modules of a memory 660 shown in FIG. 6. For example, the mobile device 600 can include an encryption module 762 and a data access module 768. The mobile device 600 may also include one or more additional functional modules that provide other functionality to the mobile device 600. The mobile device 600 illustrated in FIGS. 6 and 7 can be used to implement the process illustrated in FIG. 8.

The encryption module 762 can be configured to encrypt configuration data according to the algorithm transformation and/or the algorithm randomization techniques disclosed herein. The encryption module 762 can be configured to implement one or more encryption algorithms that can be used to encrypt data. The encryption module 762 can be configured to encrypt data for one or more applications on the mobile device 600. For example, the encryption module 762 can be configured to encrypt data received from an application operating on the mobile device 600 to prevent unauthorized access to the data. The encryption module 762 can be configured to store the encrypted data in memory 660 by providing the encrypted data to the data access module 768. The encryption module 762 can also be configured to decrypt data received from an application operating on the mobile device 600. For example, an email application running on the mobile device may download an email that has an encrypted attachment and the email application can be configured to decrypt the encrypted attachment if the key or keys needed to decrypt the attachment are available to the encryption module 762.

The encryption module 762 can be configured to access one or more keys that can be used by one or more stage of an encryption algorithms implemented by the encryption module 762. The encryption module 762 can be configured to store the keys in a protected area of memory 260 or other memory of the mobile device 600 for which access is restricted. The encryption module 762 can be configured to access the one or more keys via the data access module 768. The encryption module 762 can be configured to use the keys to encrypt and/or decrypt data.

The data access module 768 can be configured to store data in the memory 660 and/or other data storage devices associated with the mobile device 600. The data access module 768 can also be configured to access data in the memory 660 and/or other data storage devices associated with the mobile device 600. The data access module 768 can be configured to receive requests from other modules and/or components of the mobile device 600 and to store and/or access data stored in the memory 660 and/or other data storage devices associated with the mobile device 600.

### Example Implementations

FIG. 8 is a flow diagram of a process for encrypting data that can be used to implement the encryption techniques disclosed herein. The process illustrated in FIG. 8 can be implemented in hardware, software, or a combination thereof. For example, the process illustrated in FIG. 8 can be implemented by the mobile device 600 illustrated in FIGS. 6 and 7. The process illustrated in FIG. 8 can also be implemented in a circuit, such as the example circuit illustrated in FIG. 5.

One or more first stages of a cryptographic algorithm can be applied to data to be encrypted to generate first intermediate data (stage 805). The one or more first stages of the cryptographic algorithm to be applied can depend on which stage of the algorithm the protection provided and how many stages are included in a particular implementation of the cryptographic algorithm. For example, in implementations where the cryptographic algorithm is an AES cryptographic algorithm, the number of rounds performed depends on the key length used by that particular implementation. The AES-128 algorithm uses a key length of 128 bits, the AES-192 algorithm uses a key length of 192 bits, and the AES-256 algorithm uses a key length of 256 bits. The key size affects the number of rounds that will be executed. For example, AES-128 implementations typically include 10 rounds, AES-192 implementations typically include 12 rounds, and AES-256 implementations typically include 14 rounds.

One common point of attack on the AES algorithms is between the first and second rounds. Another common point of attack on the AES algorithm is between the next to last and the last rounds of the algorithm. For example, a common point of attack on the AES-128 algorithm is at the 9^{th} and 10^{th} rounds, a common point of attack on the AES-192 algorithm is at the 11^{th} and 12^{th} rounds, and a common point of attack on the AES-256 algorithm is at the 13^{th} and 14^{th} rounds. Accordingly, the one or more first stages of the cryptographic algorithm can be the first round of one of the AES algorithms. The one or more first stages of the cryptographic algorithms can also refer to the next to last round one an AES algorithm, such as the 9^{th} round of the AES-128 algorithm, the 10^{th} round of the AES-192 algorithm, and the 13^{th} round of the AES-256 algorithm. The number of the next to last round may vary for other cryptographic algorithms.

The attacker may use a power analysis attack, such as those described above to observe electrical activity of the device in which the cryptographic algorithm has been implemented over a period of time to develop power traces. The power traces can be used to extract the cryptographic keys used by the algorithm.

The order of first intermediate data can be permuted according to a predetermined permutation to produce permuted intermediate data (stage 810). The order of the bytes of the first intermediate data can be permuted according a predetermined permutation pattern to produce permuted intermediate data. In some implementations, the predetermined permutations may be performed according to an algorithm transformation technique similar to that of the algorithm transformation technique 214 illustrated in FIG. 2. In the algorithm transformation technique, a transformation function can be implemented in the software and/or the hardware in which the encryption algorithm is implemented. The transformation function can reorder the bytes of the input data according to a predetermined pattern that can be reversed using an inverse permutation function once the next stage or stages of the cryptographic algorithm have been applied to the input data. FIG. 3 illustrates an example of such a transformation function being applied to input data of a round of an AES encryption algorithm. The 16 bytes of input data are represented as a 4×4 matrix of data. The transformation function permutes the order of the bytes of the input data so that the bytes of the input data are no longer located in the same order that they were in when output from a previous AES round. In other implementations, an algorithm randomization technique may be employed similar to that of the randomization algorithm 220 illustrated in FIG. 2. In the algorithm randomization technique, the transformation function used to permute the input data is not static and can be selected from multiple predetermined permutation function. For example, a particular implementation of the algorithm randomization technique may include a set of five transformation functions that each permute the input data in a different pattern. The algorithm randomization technique can also implement a means for selecting one of the five predetermined transformation functions to apply to the input data. Randomly selecting one of the transformation algorithms to permute the input data can make power analysis and other types of attacks on the cryptographic algorithm in an attempt to uncover the keys being used much more difficult. In some implementations, a random seed value can be generated and fed into a multiplexer that selects a transformation function to apply to the input data. For both the algorithm transformation and the algorithm randomization techniques discussed above, the permutation pattern or patterns used should be kept secret if possible. Other techniques can also be used to select which transformation function is to be applied. For example, a round robin or other selection scheme can be used instead of the random seed value to select which transformation function is to be applied. In some implementations one or more fixed selection patterns may be implemented and can be used instead of a random seed to determine which transformation function is to be applied.

A key to be used by one or more second stages of a cryptographic algorithm can be permuted according to the predetermined permutation (stage 815). The key to be used by the cryptographic algorithm to operate on the first intermediate data can also be permuted according to the same transformation algorithm transformation that has been applied to the input values. The example illustrated in FIG. 3 provides an example of a key being permuted using the same transformation algorithm as the input data. The key may be used by multiple stages of the cryptographic algorithm or may be specific to one stage of the cryptographic algorithm. For example, the AES algorithms require a separate key for each round that are derived from the main cipher key using Rijndael's key schedule, a technique which can be used to expand a short key into a number of separate round keys.

The one or more second stages of a cryptographic algorithm can be applied to the permuted intermediate data to generate second intermediate data (stage 820). The one or more second stages of the cryptographic algorithm can use the permuted key generated in stage 815. The example illustrated in FIG. 3, provides an example where the steps of an AES round are applied to the permuted intermediate data, which in the example of FIG. 3 is a 4×4 matrix of input values that were output by a previous round of the AES algorithm. The permuted key from stage 815 is also used in the AES round. Where the techniques disclosed herein are applied to other cryptographic algorithms, the input values and/or the type of key used by the one or more second stages of the cryptographic algorithm may differ from those used in the AES example provided in FIG. 3.

The second intermediate data can be permuted according to an inverse permutation of the predetermined permutation to generate output (stage 825). The second intermediate data can be permuted using an inverse permutation of the permutation applied in stages 810 and 820 to generate an output that is the same as the output of the one or more second stages of the unmodified cryptographic algorithm would generate. For example, referring back to the example of FIG. 3, the inverse permutation associated with the transformation function that was applied to permute the input date and the subkey associated with that round is applied to the permuted intermediate data to reorder the bytes of the permuted intermediate data so that the bytes are in the same order that the bytes would have been in had the conventional AES cryptographic algorithm been applied instead of the modified cryptographic technique disclosed herein. Accordingly, the techniques disclosed herein do not require that the operations performed by the cryptographic algorithm in each of the stage or rounds be modified to work with these techniques. The techniques can be applied at one or more stages or rounds of the cryptographic algorithm that may be targeted by power analysis attacks, EM attacks, and/or other types of side-channel attacks.

The output from stage 825 may be used as an input to one or more subsequent stages of the cryptographic algorithm. For example, where the cryptographic algorithm is an AES algorithm and where the one or more second stages of the cryptographic algorithm correspond to round 2 of one of the AES algorithm, the output from round 2 will be processed by several additional rounds before the ciphertext is output by the algorithm. Where the cryptographic algorithm is an AES algorithm and where the one or more second stages of the cryptographic algorithm correspond to the last round of one of the AES algorithm, the output from the last round will be processed by several additional rounds before the ciphertext is output by the algorithm.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method for encrypting data comprising:
permuting an order of first intermediate data according to a predetermined permutation to produce permuted intermediate data, the first inter mediate data being output by one or more first stages of a cryptographic algorithm;
permuting a key to be used by one or more second stages of the cryptographic algorithm according to the predetermined permutation;
applying the one or more second stages of the cryptographic algorithm to the permuted intermediate data to generate second intermediate data, the one or more second stages of the cryptographic algorithm using the permuted key; and
permuting the second intermediate data according to an inverse permutation of the predetermined permutation to generate output.

2. The method of claim 1, further comprising:
applying the one or more first stages of the cryptographic algorithm to data to be encrypted to generate the first intermediate data.

3. The method of claim 1, further comprising:
selecting a permutation from a set of permutations, wherein permuting the order of the first intermediate data according to the predetermined permutation to produce permuted intermediate data comprises permuting the order of the first intermediate data using the selected permutation.

4. The method of claim 3 wherein selecting the permutation from the set of permutations comprises:
generating a random number seed value; and
selecting the permutation from the set of permutations based on the random number seed value.

5. The method of claim 3 wherein selecting the permutation from the set of permutations comprises:
selecting the permutation from the set of permutations based on a predetermined pattern.

6. The method of claim 1 wherein permuting the second intermediate data according to the inverse permutation of the predetermined permutation to generate the output comprises selecting the inverse permutation from a set of inverse permutations based on the selected permutation.

7. The method of claim 1 wherein the cryptographic algorithm is an Advanced Encryption Standard (AES) algorithm, and wherein the one or more first stages of the cryptographic algorithm comprise a first round of the AES algorithm and the one or more second stages of the cryptographic algorithm comprise a second round of the AES algorithm or the one or more first stages of the cryptographic algorithm comprise a next to last round of the AES algorithm and the one or more second stages of the cryptographic algorithm comprise a final round of the AES algorithm.

8. A system for encrypting data comprising:
means for permuting an order of first intermediate data according to a predetermined permutation to produce permuted intermediate data, the first inter mediate data being output by one or more first stages of a cryptographic algorithm;
means for permuting a key to be used by one or more second stages of a cryptographic algorithm according to the predetermined permutation;
means for applying the one or more second stages of the cryptographic algorithm to the permuted intermediate data to generate second intermediate data, the one or more second stages of the cryptographic algorithm using the permuted key; and
means for permuting the second intermediate data according to an inverse permutation of the predetermined permutation to generate output.

9. The system of claim 8, further comprising:
means for applying the one or more first stages of the cryptographic algorithm to data to be encrypted to generate the first intermediate data.

10. The system of claim 8, further comprising:
means for selecting a permutation from a set of permutations, and
wherein the means for permuting the order of the first intermediate data according to the predetermined permutation to produce permuted intermediate data comprises means for permuting the order of the first intermediate data using the selected permutation.

11. The system of claim 10 wherein the means for selecting the permutation from the set of permutations comprises:
means for generating a random number seed value; and
means for selecting the permutation from the set of permutations based on the random number seed value.

12. The system of claim 10 wherein the means for selecting the permutation from the set of permutations comprises:
means for generating a random number seed value; and
means for selecting the permutation from the set of permutations based on the random number seed value.

13. The system of claim 8 wherein the means for permuting the second intermediate data according to the inverse permutation of the predetermined permutation to generate the output comprises means for selecting the inverse permutation from a set of inverse permutations based on the selected permutation.

14. The system of claim 8 wherein the cryptographic algorithm is an Advanced Encryption Standard (AES) algorithm, and wherein the one or more first stages of the cryptographic algorithm comprise a first round of the AES algorithm and the one or more second stages of the cryptographic algorithm comprise a second round of the AES algorithm or the one or more first stages of the cryptographic algorithm comprise a next to last round of the AES algorithm and the one or more second stages of the cryptographic algorithm comprise a final round of the AES algorithm.

15. A non-transitory computer-readable medium, having stored thereon computer-readable instructions for encrypting data, comprising instructions configured to cause a computer to:
permute an order of first intermediate data according to a predetermined permutation to produce permuted intermediate data, the first inter mediate data being output by one or more first stages of a cryptographic algorithm;
permute a key to be used by one or more second stages of the cryptographic algorithm according to the predetermined permutation;
apply the one or more second stages of the cryptographic algorithm to the permuted intermediate data to generate second intermediate data, the one or more second stages of the cryptographic algorithm using the permuted key; and
permute the second intermediate data according to an inverse permutation of the predetermined permutation to generate output.

16. The non-transitory computer-readable medium of claim 15, further comprising instructions configured to cause the computer to:
apply the one or more first stages of the cryptographic algorithm to data to be encrypted to generate the first intermediate data.

17. The non-transitory computer-readable medium of claim 15, further comprising instructions configured to cause the computer to:
select a permutation from a set of permutations, and
wherein the instructions configured to cause the computer to permute the order of the first intermediate data according to the predetermined permutation to produce permuted intermediate data comprise instructions configured to cause the computer to permute the order of the first intermediate data using the selected permutation.

18. The non-transitory computer-readable medium of claim 17 wherein the instructions configured to cause the computer to select the permutation from the set of permutations comprise instructions configured to cause the computer to:
generate a random number seed value; and
select the permutation from the set of permutations based on the random number seed value.

19. The non-transitory computer-readable medium of claim 17 wherein the instructions configured to cause the computer to select the permutation from the set of permutations comprise instructions configured to cause the computer to:
select the permutation from the set of permutations based on a predetermined pattern.

20. The non-transitory computer-readable medium of claim 15 wherein the instructions configured to cause the computer to permute the second intermediate data according to the inverse permutation of the predetermined permutation to generate the output comprise instructions configured to cause the computer to select the inverse permutation from a set of inverse permutations based on the selected permutation.

21. The non-transitory computer-readable medium of claim 15 wherein the cryptographic algorithm is an Advanced Encryption Standard (AES) algorithm, and wherein the one or more first stages of the cryptographic algorithm comprise a first round of the AES algorithm and the one or more second stages of the cryptographic algorithm comprise a second round of the AES algorithm or the one or more first stages of the cryptographic algorithm comprise a next to last round of the AES algorithm and the one or more second stages of the cryptographic algorithm comprise a final round of the AES algorithm.

22. A circuit for encrypting data comprising:
a first set of components configured to permute an order of the first intermediate data according to a predetermined permutation to produce permuted intermediate data, the first inter mediate data being output by one or more first stages of a cryptographic algorithm;
a second set of components configured to permute a key to be used by one or more second stages of the cryptographic algorithm according to the predetermined permutation;
a third set of components configured to apply the one or more second stages of the cryptographic algorithm to the permuted intermediate data to generate second intermediate data, the one or more second stages of the cryptographic algorithm using the permuted key; and
a fourth set of components configured to permute the second intermediate data according to an inverse permutation of the predetermined permutation to generate output.

23. The circuit of claim 22, further comprising:
a fifth set of components configured to apply the one or more first stages of the cryptographic algorithm to data to be encrypted to generate the first intermediate data.

24. The circuit of claim 22, further comprising:
a sixth set of components configured to select a permutation from a set of permutations, wherein permuting the order of the first intermediate data according to the predetermined permutation to produce permuted intermediate data comprises permuting the order of the first intermediate data using the selected permutation.

25. The circuit of claim 24 wherein the sixth set of components is further configured to:
generate a random number seed value; and
select the permutation from the set of permutations based on the random number seed value.

26. The circuit of claim 24 wherein the sixth set of components is further configured to:
select the permutation from the set of permutations based on a predetermined pattern.

27. The circuit of claim 22 wherein the fourth set of components is configured to select the inverse permutation from a set of inverse permutations based on the selected permutation.

28. The circuit of claim 22 wherein the cryptographic algorithm is an Advanced Encryption Standard (AES) algorithm, and wherein the one or more first stages of the cryptographic algorithm comprise a first round of the AES algorithm and the one or more second stages of the cryptographic algorithm comprise a second round of the AES algorithm or the one or more first stages of the cryptographic algorithm comprise a next to last round of the AES algorithm and the one or more second stages of the cryptographic algorithm comprise a final round of the AES algorithm.
